(19) United States
(12) Patent Application Publication
(10) Pub. No.: US 2004/0012674 A1
(43) Pub. Date: Jan. 22, 2004

(54) Surveillance camera apparatus

(76) Inventor: Jouji Wada, Kanagawa-ken (JP)

Correspondence Address: PEARNE & GORDON LLP, 1801 EAST 9TH STREET, SUITE 1200, CLEVELAND, OH, 44114-3108, US

(21) Appl. No.: 10/615,700

(22) Filed: Jul. 8, 2003

(30) Foreign Application Priority Data
Jul. 8, 2002 (JP) 2002-199087

(51) Int. Cl. H04N 5/225

(52) U.S. Cl. 348/169; 348/373

(57) ABSTRACT

A surveillance camera apparatus comprises a camera retaining assembly, a camera unit being movable with respect to the camera retaining assembly to a destined position and posture, a micro-computer unit for producing a position signal indicative of the destined position and posture, and being operative to take two different operation states consisting of a regular state to produce a regular state signal indicative of the regular state for every first predetermined time interval, and an irregular state not to produce the position signal, a resetting unit for resetting the micro-computer unit to take the regular state, a camera driving unit for driving the camera unit to move, a camera drive control unit being operative to take two different control states consisting of a first control state under which the camera unit is driven to move to the destined position and posture represented by the position signal, and a second control state under which the camera unit is driven to move into engagement with the resetting unit to have the micro-computer unit to be reset, and a control state setting unit for setting the camera drive control unit to take the first control state when receiving the regular state signal within a second predetermined time interval longer than the first predetermined interval, while setting the camera drive control unit to take the second control state when not receiving the regular state signal within the second predetermined time interval. The surveillance camera apparatus thus constructed can reduce an operation time and lessen a laborious task for the operator to reset the micro-computer unit.

### BACKGROUND OF THE INVENTION

1. Field of the Invention

The present invention relates to a surveillance camera apparatus available for surveillance system for watching a specific object such as for example unqualified people and other intruders intruding into a special room which does not permit people with any permission from entering, and more particularly to a surveillance camera apparatus which can be reset to operate without any laborious task when a micro-computer constituting part of the surveillance camera apparatus is brought into a frozen state to fail to execute a micro-computer program thereof.

2. Description of the Related Art

Up until now, there have been proposed a wide variety of conventional surveillance camera apparatus which can be reset to operate when a micro-computer constituting part of the surveillance camera apparatus is brought into a frozen state.

One of the typical examples of the surveillance camera apparatuses thus known is shown in FIGS. 10 and 11 as having a reference number 100. The conventional surveillance camera apparatus 100 comprises a stationary member 101, a camera unit 102 for taking an image of a specific object, a camera retaining assembly 103 for retaining the camera unit 102. The camera unit 102 and the camera retaining assembly 103 are combined to constitute a camera mechanism 104 shown in FIG. 11. The camera retaining assembly 103 includes a camera shaft 105 having a camera revolution axis 105a thereof, a holder member 106, and a holder shaft 107 having a holder revolution axis 107a thereof. The camera shaft 105 is supported by the holder member 106 to be revolvable around the camera revolution axis 105a in unison with the camera unit 102 as seen by an arrow 105b in FIG. 10. The holder shaft 107 is securely mounted on the holder member 106 and supported by the stationary member 101 to be revolvable around the holder revolution axis 107a with respect to the stationary member 101 as seen by an arrow 107b in FIG. 10. The camera unit 102 is movable with respect to the stationary member 101 to a destined position and posture to be decided and controlled by a micro-computer unit which will become apparent as the description proceeds.

The conventional surveillance camera apparatus 100 further comprises a printed circuit board 108, and a micro-computer unit 109 for producing a position signal indicative of the destined position and posture. The micro-computer unit 109 is operative to take two different operation states consisting of a regular state to produce the position signal, and an irregular state not to produce the position signal when the micro-computer unit 109 is accidentally brought into a frozen state.

The conventional surveillance camera apparatus 100 further comprises a resetting unit 110 for resetting the micro-computer unit 109 to take the regular state from the irregular state, an I/O (Input Output) port 111 for transmitting to the micro-computer unit 109 from an exterior controller 120 an operation command to have the micro-computer unit 109 operate to produce the position signal, a camera driving unit 112 for driving the camera unit 102 revolve around the camera revolution axis 105a with respect to the holder member 106, and a holder driving unit 113 for driving the holder member 106 to revolve around the holder revolution axis 107a with respect to the stationary member 101. The camera driving unit 112 includes a camera electric motor 114 for transmitting revolution torques to the camera shaft 105 to have the camera unit 102 revolve around the camera revolution axis 105a with respect to the holder member 106, and a camera encoder 115 for counting and encoding the revolution number of the camera electric motor 114, while the holder driving unit 113 includes a holder electric motor 116 for transmitting revolution torques to the holder shaft 107 to have the holder member 106 revolve around the holder revolution axis 107a with respect to the stationary member 101, and a holder encoder 117 for counting and encoding the revolution number of the holder electric motor 116.

The conventional surveillance camera apparatus 100 further comprises a camera drive control unit 118 for controlling the camera driving unit 112 to have the camera driving unit 112 drive the camera unit 102 to revolve around the camera revolution axis 105a with respect to the holder member 106 to the destined position and posture represented by the position signal produced by the micro-computer unit 109, and a holder drive control unit 119 for controlling the holder driving unit 113 to have the holder driving unit 113 drive the holder member 106 to revolve around the holder revolution axis 107a with respect to the stationary member 101 to the destined position and posture represented by the position signal produced by the micro-computer unit 109.

The micro-computer unit 109 constituting part of the conventional surveillance camera apparatus 100 is reset by the resetting unit 110 handled by an operator, when the micro-computer unit 109 is brought into a frozen state.

The conventional surveillance camera apparatus, however, encounters such a problem that the conventional surveillance camera apparatus is operated by the exterior controller remote from the conventional surveillance camera apparatus, thereby resulting in the fact that the operation needs a large amount of time and a laborious task for the operator to reset the micro-computer unit after the operator reaches the conventional surveillance camera apparatus from the exterior controller.

### SUMMARY OF THE INVENTION

It is, therefore, an object of the present invention to provide a surveillance camera apparatus which can not only reduce the operation time but also lessen the laborious task for the operator to reset the micro-computer constituting part of the surveillance camera apparatus when the micro-computer is brought into the frozen state.

In accordance with a first aspect of the present invention, there is provided a surveillance camera apparatus, comprising: a camera unit for taking an image of a specific object; a camera retaining assembly for retaining the camera unit, the camera unit being movable with respect to the camera retaining assembly to a destined position and posture; a micro-computer unit for producing a position signal indicative of the destined position and posture, the micro-computer unit being operative to take two different operation states consisting of a regular state to produce a regular state signal indicative of the regular state for every first predetermined time interval, and an irregular state not to produce the position signal; a resetting unit for resetting the micro-computer unit to take the regular state from the irregular state; a camera driving unit for driving the camera unit to move with respect to the camera retaining assembly; a camera drive control unit for controlling the camera driving unit to have the camera driving unit drive the camera unit to move with respect to the camera retaining assembly, the camera drive control unit being operative to take two different control states consisting of a first control state under which the camera unit is driven to move to the destined position and posture represented by the position signal produced by the micro-computer unit, and a second control state under which the camera unit is driven to move into engagement with the resetting unit to have the micro-computer unit to be reset; and a control state setting unit for setting the camera drive control unit to take the first control state when receiving the regular state signal from the micro-computer unit within a second predetermined time interval longer than the first predetermined interval, while setting the camera drive control unit to take the second control state when not receiving the regular state signal from the micro-computer unit within the second predetermined time interval.

The camera unit may have a surveillance area where the camera unit is driven by the camera driving unit to move with respect to the camera retaining assembly to taking an image of the specific object, and a non-surveillance area where the camera unit is driven by the camera driving unit to move with respect to the camera retaining assembly into engagement with the resetting unit in the outside of the surveillance area.

The control state setting unit may include: signal receiving means for receiving the regular state signal produced by the micro-computer unit; interval measuring means for measuring a lap time interval starting from the time when the regular state signal is received by the signal receiving means; and time interval comparing means for comparing the lap time interval and the second predetermined time interval, and deciding whether or not the lap time interval exceeds the second predetermined time interval based on the compared lap time interval and second predetermined time interval.

The surveillance camera apparatus may further comprise an operation state setting unit for selectively setting the micro-computer unit to take the regular and irregular states.

The surveillance camera apparatus may further comprise an operation state setting unit for repeatedly setting the micro-computer unit to take the regular and irregular states in predetermined time interval having two different time intervals consisting of a first time interval in which the micro-computer unit is set to take the regular mode, and a second time interval in which the micro-computer unit is set to take the irregular mode.

The camera retaining assembly may include a camera shaft having a camera revolution axis thereof, and a holder member for revolvably supporting the camera shaft; and the camera shaft may be driven in unison with the camera by the camera driving unit to revolve around the camera revolution axis with respect to the camera retaining assembly.

The camera retaining assembly may include a holder shaft securely mounted on the holder member and having a holder revolution axis thereof, and the surveillance camera apparatus may further comprise: a stationary member; a holder driving unit for driving the holder member of the camera retaining assembly to revolve around the holder revolution axis with respect to the stationary member; and a holder drive control unit for controlling the holder driving unit to have the holder driving unit drive the holder member to revolve around the holder revolution axis with respect to the stationary member to the destined position and posture represented by the position signal produced by the micro-computer unit.

In accordance with a second aspect of the present invention, there is provided a surveillance camera apparatus, comprising: a stationary member; a camera unit for taking an image of a specific object; a camera retaining assembly for retaining the camera unit, the camera retaining assembly including a camera shaft having a camera revolution axis thereof, a holder member for revolvably supporting the camera shaft to revolve around the camera revolution axis with respect to the holder member, and a holder shaft having a holder revolution axis thereof, the holder shaft securely mounted on the holder member and being supported by the stationary member to revolve around the holder revolution axis with respect to the stationary member, and the camera unit being revolvable with respect to the stationary member and the holder member to a destined position and posture; a micro-computer unit for producing a position signal indicative of the destined position and posture, the micro-computer unit being operative to take two different operation states consisting of a regular state to produce a regular state signal indicative of the regular state for every first predetermined time interval, and an irregular state not to produce the position signal; a resetting unit for resetting the micro-computer unit to take the regular state from the irregular state; a camera driving unit for driving the camera unit to revolve around the camera revolution axis with respect to the holder member; a holder driving unit for driving the holder member of the camera retaining assembly to revolve around the holder revolution axis with respect to the stationary member; a camera drive control unit for controlling the camera driving unit to have the camera driving unit drive the camera unit to revolve around the camera revolution axis with respect to the holder member; a holder drive control unit for controlling the holder driving unit to have the holder driving unit drive the holder member to revolve around the holder revolution axis with respect to the stationary member, the camera drive control unit and the holder drive control unit being respectively operative to take two different control states consisting of a first control state under which the camera unit is driven to move to the position and posture represented by the position signal produced by the micro-computer unit, and a second control state under which the camera unit is driven to move into engagement with the resetting unit to have the micro-computer unit to be reset; and a control state setting unit for setting each of the camera drive control unit and holder drive control unit to take the first control state when receiving the regular state signal from the micro-computer unit within a second predetermined time longer than the first predetermined interval, while setting each of the camera drive control unit and holder drive control unit to take the second control state when not receiving the regular state signal from the micro-computer unit within the second predetermined time.

### BRIEF DESCRIPTION OF THE DRAWINGS

The features and advantages of the surveillance camera apparatus according to the present invention will more clearly be understood from the following description taken in conjunction with the accompanying drawings in which:

FIG. 1 is a block diagram of a first preferred embodiment of the surveillance camera apparatus according to the present invention;

FIG. 2 is a perspective view of the surveillance camera apparatus shown in FIG. 1;

FIG. 3 is a block diagram of a control state setting unit forming part of the surveillance camera apparatus shown in FIG. 1;

FIG. 4 is a timing chart showing an electric potential produced by a capacitor forming part of the control state setting unit shown in FIG. 3, a regular state signal produced by a micro-computer unit forming part of the surveillance camera apparatus shown in FIG. 1;

FIG. 5 is a block diagram of a second preferred embodiment of the surveillance camera apparatus according to the present invention;

FIG. 6 is a perspective view of the surveillance camera apparatus shown in FIG.5;

FIG. 7 is a block diagram of a control state setting unit forming part of the surveillance camera apparatus shown in FIG. 5;

FIG. 8 is a block diagram of a third preferred embodiment of the surveillance camera apparatus according to the present invention;

FIG. 9 is a perspective view of the surveillance camera apparatus shown in FIG. 8;

FIG. 10 is a perspective view of the conventional surveillance camera apparatus; and

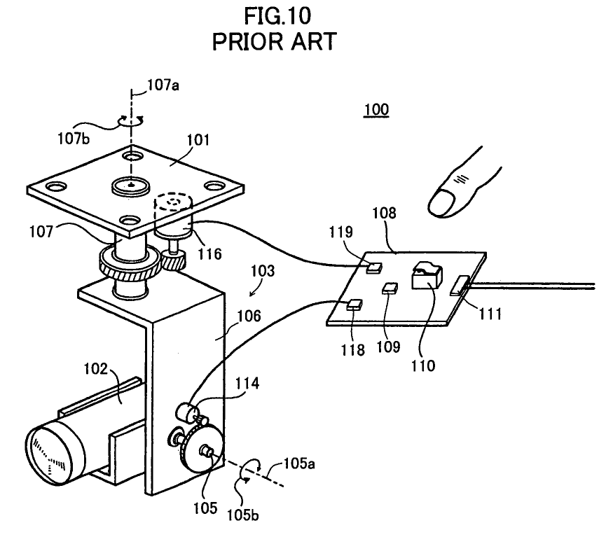

FIG. 11 is a block diagram of the conventional surveillance camera apparatus shown in FIG. 10.

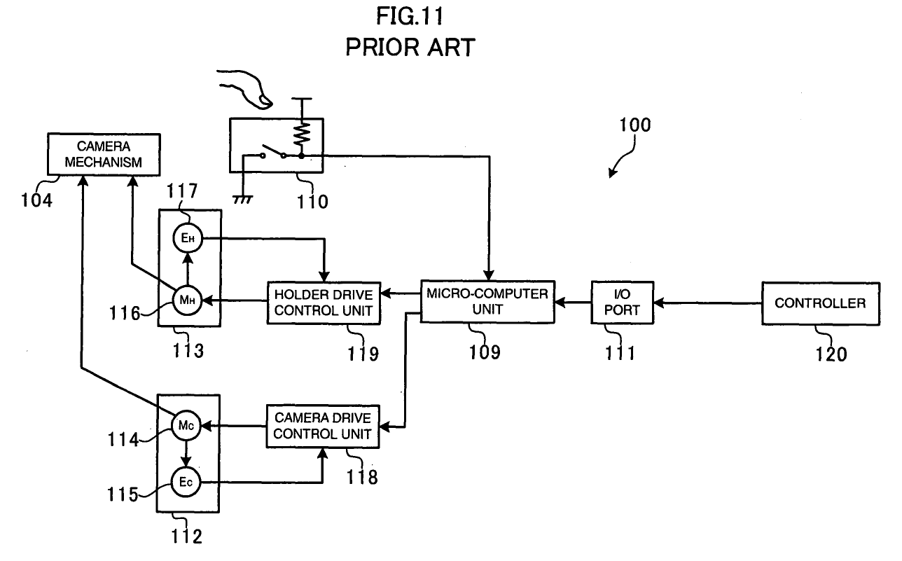

### DESCRIPTION OF THE EMBODIMENTS

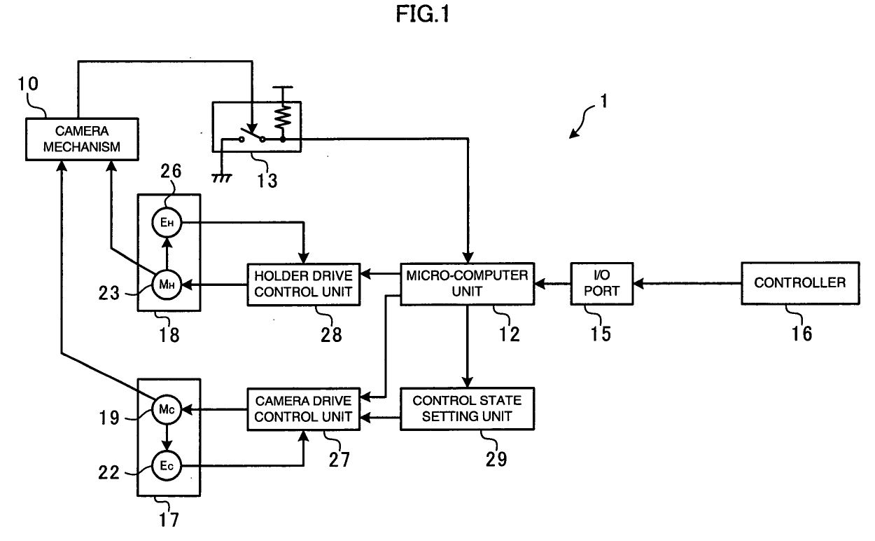

Referring now to the drawings, in particular to FIGS. 1 to 4, there is shown the first preferred embodiment of the surveillance camera apparatus according to the present invention. Throughout the following detailed description, similar reference numbers refer to respective similar elements or parts in all figures of the drawings.

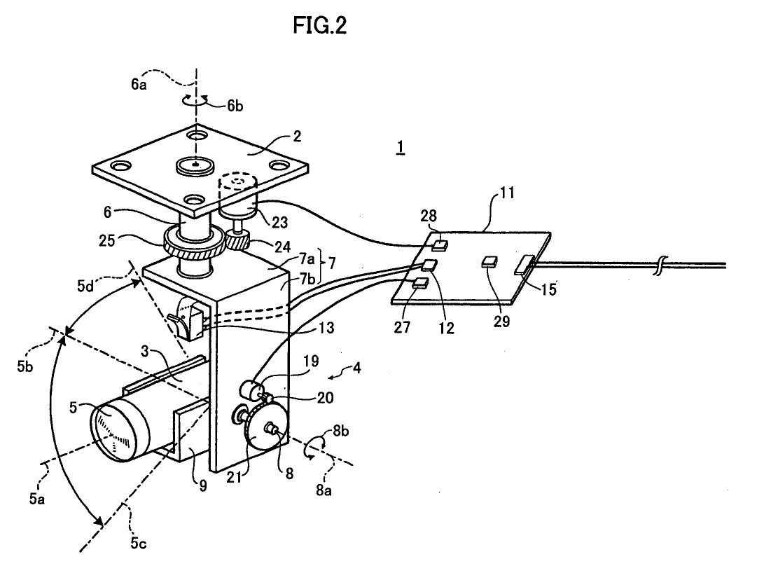

The first preferred embodiment of the surveillance camera apparatus is shown in FIGS. 1 and 2 as having a reference number 1, and comprises a stationary member 2, a camera unit 3 for taking an image of a specific object, a camera retaining assembly 4 for retaining the camera unit 3. The camera unit 3 and the camera retaining assembly 4 are combined to constitute a camera mechanism 10 shown in FIG. 1. The stationary member 2 has a plurality of bolt holes each having a bolt pass therethrough to secure the stationary member 2 to a camera structure not shown. The camera unit 3 includes a lens 5 having a light axis 5a and a charge coupled device unit having a plurality of charge coupled devices designed to translate lights received through the lens 5 to an image signal.

The camera retaining assembly 4 includes a holder shaft 6, a holder member 7, a camera shaft 8, and a channel member 9. The holder shaft 6 has a first end portion revolvably connected to the stationary member 2, a second end portion securely connected to the holder member 7. The holder shaft 6 has a holder revolution axis 6a thereof, and is revolvable around the holder revolution axis 6a with respect to the stationary member 2 as seen by an arrow 6b in FIG. 2. The camera shaft 8 has a fixed end portion revolvably supported on the holder member 7 and a free end portion extending from the holder member 7. The camera shaft 8 has a camera revolution axis 8a thereof, and is revolvable around the camera revolution axis 8a with respect to the holder member 7 as seen by an arrow 8b in FIG. 2. In this embodiment, the camera revolution axis 8a of the camera shaft 8 is in perpendicular relationship with the holder revolution axis 6a of the holder shaft 6.

The holder member 7 is in the form of L-shape in cross-section and has a first plate portion 7a having a surface paralleled to that of the stationary member 2, and a second plate portion 7b integrally formed with the first plate portion 7a to have a surface to be perpendicular to that of the first plate portion 7a. The channel member 9 is securely mounted on the free end portion of the camera shaft 8 to retain the camera unit 3. The camera unit 3 is movable with respect to the stationary member 2 to a destined position and posture to be decided and controlled by a micro-computer unit which will become apparent as the description proceeds.

The surveillance camera apparatus 1 further comprises a micro-computer unit 12 for producing a position signal indicative of the destined position and posture, and a printed circuit board 11 for mounting the micro-computer unit 12. The printed circuit board 11 is shown as dismounted from the holder member 7 in FIG. 2 for the purpose of assisting in understanding, but the printed circuit board 11 is securely mounted on the holder member 7.

The micro-computer unit 12 is operative to take two different operation states consisting of a regular state to produce a regular state signal indicative of the regular state for every first predetermined time interval, and an irregular state not to produce the position signal. The micro-computer unit 12, for example, takes the irregular state when the micro-computer unit 12 is accidentally brought into a frozen state.

The surveillance camera apparatus 1 further comprises a resetting unit 13 for resetting the micro-computer unit 12 to the regular state from the irregular state, an I/O port 15 mounted on the printed circuit board 11 and adapted to transmit to the micro-computer unit 12 from an exterior controller 16 an operation command to have the micro-computer unit 12 operate to produce the position signal, a camera driving unit 17 for driving the camera unit 3 to revolve around the camera revolution axis 8a with respect to the holder member 7, and a holder driving unit 18 for driving the holder member 7 to revolve around the holder revolution axis 6a with respect to the stationary member 2. The resetting unit 13 is securely supported by the holder member 7.

The camera driving unit 17 includes a camera electric motor 19 securely mounted on the holder member 7, a camera drive gear 20 driven by the camera electric motor 19, a camera driven gear 21 integrally coupled with the camera shaft 8 to be meshed with the camera drive gear 20 to be driven by the camera drive gear 20, and a camera encoder 22 for counting and encoding the revolution number of the camera electric motor 19. The camera drive gear 20 has a gear number smaller than that of the camera driven gear 21 to reduce the revolution of the camera shaft 8. It is preferable that the camera electric motor 19 and the camera encoder 22 are combined to be constituted by a step-motor.

The holder driving unit 18 includes a holder electric motor 23 securely mounted on the stationary member 2, a holder drive gear 24 driven by the holder electric motor 23, a holder driven gear 25 integrally coupled with the holder shaft 6 to be meshed with the holder drive gear 24 to be driven by the holder drive gear 24, and a holder encoder 26 for counting and encoding the revolution number of the holder electric motor 23. The holder drive gear 24 has a gear number smaller than that of the holder driven gear 25 to reduce the revolution of the holder shaft 6. It is preferable that the holder electric motor 23 and the holder encoder 26 are combined to be constituted by a step-motor.

The surveillance camera apparatus 1 further comprises a camera drive control unit 27 mounted on the printed circuit board 11 and adapted to control the camera driving unit 17 to have the camera driving unit 17 drive the camera unit 3 to revolve around the camera revolution axis 8a with respect to the holder member 7, and a holder drive control unit 28 mounted on the printed circuit board 11 and adapted to control the holder driving unit 18 to have the holder driving unit 18 drive the holder member 7 to revolve around the holder revolution axis 6a with respect to the stationary member 2 to the destined position and posture represented by the position signal produced by the micro-computer unit 12.

The camera drive control unit 27 is operative to take two different control states consisting of a first control state under which the camera unit 3 is driven to move to the destined position and posture represented by the position signal produced by the micro-computer unit 12, and a second control state under which the camera unit 3 is driven to move into engagement with the resetting unit 13 to have the micro-computer unit 12 to be reset. The camera unit 3 has a surveillance area where the camera unit 3 is driven by the camera driving unit 17 to revolvably move with respect to the holder member 7 of the camera retaining assembly 4 to taking an image of the specific object, and a non-surveillance area where the camera unit 3 is driven by the camera driving unit 17 to revolvably move with respect to the holder member 7 of the camera retaining assembly 4 into engagement with the resetting unit 13 in the outside of the surveillance area. In this embodiment, the surveillance area is defined as an angle range in which the light axis 5a of the lens 5 of the camera unit 3 takes between dashed lines 5b and 5c, while the non-surveillance area is defined as an angle range in which the light axis 5a of the lens 5 of the camera unit 3 takes between dashed lines 5c and 5d.

The surveillance camera apparatus 1 further comprises a control state setting unit 29 mounted on the printed circuit board 11. The control state setting unit 29 is operative to set the camera drive control unit 27 to take the first control state when receiving the regular state signal from the micro-computer unit 12 within a second predetermined time interval longer than the first predetermined interval, while to set the camera drive control unit 27 to take the second control state when not receiving the regular state signal from the micro-computer unit 12 within the second predetermined time interval.

The control state setting unit 29 includes signal receiving means for receiving the regular state signal produced by the micro-computer unit 12, interval measuring means for measuring a lap time interval starting from the time when the regular state signal is received by the signal receiving means, and time interval comparing means for comparing the lap time interval and the second predetermined time interval, and deciding whether or not the lap time interval exceeds the second predetermined time interval based on the compared lap time interval and second predetermined time interval.

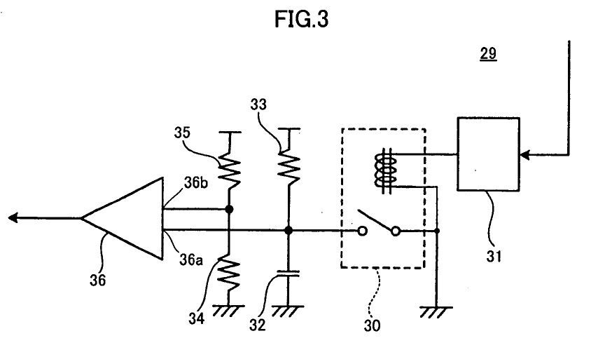

As best shown in FIG. 3, the interval measuring means includes a capacitor 32 for accumulating an electrical charge therein, the capacitor 32 having a first electrical potential associated with the lap time interval, and the capacitor 32 being designed to take two different states consisting of a first state to accumulate the electrical charge therein, and a second state to discharge the electrical charge, and a first resistor 33 for having the capacitor 32 accumulate the electrical charge.

The signal receiving means includes a relay-switch 30 for switching the state of capacitor 32 from the first state to the second state and vice versa, and a relay-switch driver 31 for driving the relay-switch 30 to have the relay-switch 30 switch the state of capacitor 32 from the first state to the second state and vice versa. The relay-switch driver 31 is operative to have the relay-switch 30 switch the state of the capacitor 32 to the first state from the second state when not receiving the regular state signal from the micro-computer unit 12, and to have the relay-switch 30 switch the state of the capacitor 32 to the second state from the first state when receiving the regular state signal from the micro-computer unit 12.

The time interval comparing means includes a voltage divider for producing a second electric potential associated with the second predetermined time interval. The voltage divider has a second resistor 34 electrically connected to the earth, and a third resistor 35 engaged. The time interval comparing means further includes a comparator 36 for comparing the first electric potential produced by the capacitor 32 to the second electric potential produced by the voltage divider. The comparator 36 is operative to judge whether or not the first electric potential produced by the capacitor 32 exceeds the second electric potential produced by the voltage divider based on the compared first and second electric potential.

The operation of the surveillance camera apparatus 1 will be described in detail hereinafter with reference to in FIGS. 1 to 4.

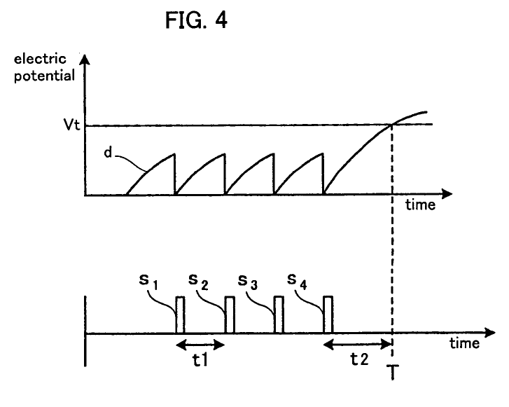

Under the condition that the micro-computer unit 12 takes the regular state, the destined position and posture is firstly decided and controlled by the micro-computer unit 12. The position signal is then produced by the micro-computer unit 12, while the regular state signal is produced by the micro-computer unit 12 for every first predetermined time interval. In FIG. 4, the reference character “t1” represents the first predetermined time interval, and the reference characters “s1”, “s2”, “s3” and “s4” each represents the regular state signal produced by the micro-computer unit 12.

When the position signal produced by the micro-computer unit 12 is received by each of the camera drive control unit 27 and holder drive control unit 28, the camera driving unit 17 is controlled by the camera drive control unit 27 to drive the camera unit 3 to revolve around the camera revolution axis 8a with respect to the holder member 7 to the destined position and posture represented by the position signal, and the holder driving unit 18 is controlled by the holder drive control unit 28 to drive the holder member 7 revolve around the holder revolution axis 6a with respect to the stationary member 2 to the destined position and posture represented by the position signal.

When, on the other hand, the regular state signal produced by the micro-computer unit 12 is received by the signal receiving means of the control state setting unit 29, the lap time interval is started to be measured by the interval measuring means of the control state setting unit 29 in accordance with the first electric potential produced by the capacitor 32 of the interval measuring means. The first electric potential is represented by the reference character “d” in FIG. 4. The lap time interval measured by the interval measuring means is then compared by the time interval comparing means of the control state setting unit 29 to the second predetermined time interval. When the judgment is made by the time interval comparing means as the lap time interval exceeds the second predetermined time interval based on the compared lap time interval and second predetermined time interval, the first and second state are taken by the camera drive control unit 27 based on results of the judgment by the time interval comparing means. In FIG. 4, the reference character “t2” represents the second predetermined time interval, and the reference character “Vt” represents the electric potential associated with the second predetermined time interval.

When the micro-computer unit 12 is accidentally brought into the frozen state, the micro-computer unit 12 takes the irregular state under which the position signal and the regular state signal are not produced by the micro-computer unit 12. This leads to the fact that the lap time interval measured by the interval measuring means of the control state setting unit 29 exceeds the second predetermined time interval. The camera drive control unit 27 is then set by the control state setting unit 29 to take the second control state at the time, for example, represented by the reference character “T” in FIG. 4.

When the camera drive control unit 27 is set by the control state setting unit 29 to take the second control state, the camera driving unit 17 is controlled by the camera drive control unit 27 to drive the camera unit 3 to move into engagement with the resetting unit 13 to have the resetting unit 13 reset the micro-computer unit 12 to take the regular state from the irregular state.

As will be understood from the foregoing description, the first preferred embodiment of the surveillance camera apparatus according to the present invention can be automatically reset without being operated by an operator when the micro-computer unit constituting part of the surveillance camera apparatus is brought into the frozen state, thereby the first preferred embodiment of the surveillance camera apparatus according to the present invention has an advantage over the prior art in reducing the operation time and lessening the laborious task for the operator to reset the micro-computer unit.

Although there has been described in the above about the first preferred embodiment of the surveillance camera apparatus according to the present invention, this embodiment may be replaced by the second and third preferred embodiments of the surveillance camera apparatus according to the present invention in order to attain the objects of the present invention. The second and third preferred embodiments of the surveillance camera apparatus will then be described hereinafter.

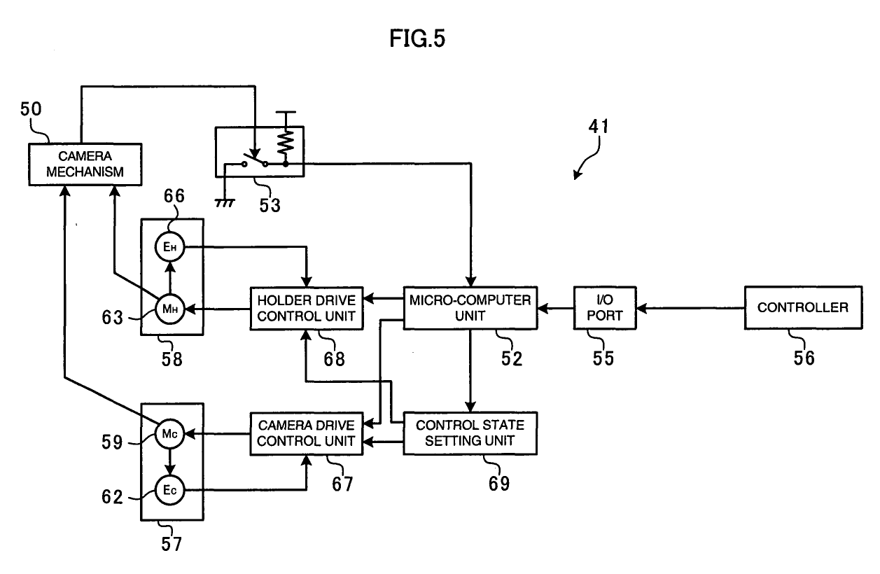

Referring then to FIGS. 5 to 7 of the drawings, there is shown the second preferred embodiment of the surveillance camera apparatus according to the present invention.

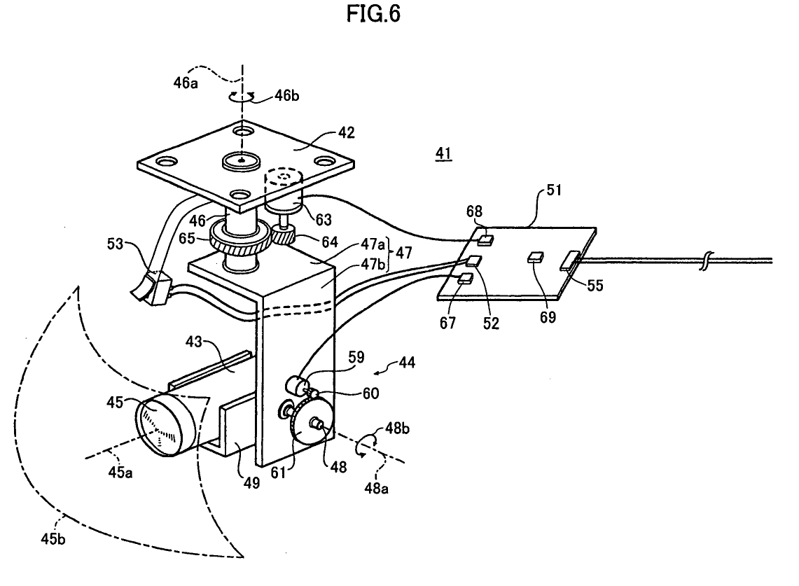

The second preferred embodiment of the surveillance camera apparatus is shown in FIGS. 5 and 6 as having a reference number 41, and comprises a stationary member 42, a camera unit 43 for taking an image of a specific object, a camera retaining assembly 44 for retaining the camera unit 43. The camera unit 43 and the camera retaining assembly 44 are combined to constitute a camera mechanism 50 shown in FIG. 5. The stationary member 42 has a plurality of bolt holes each having a bolt pass therethrough to secure the stationary member 42 to a camera structure not shown. The camera unit 43 includes a lens 45 having a light axis 45a and a charge coupled device unit having a plurality of charge coupled devices designed to translate lights received through the lens 45 to an image signal.

The camera retaining assembly 44 includes a holder shaft 46, a holder member 47, a camera shaft 48, and a channel member 49. The holder shaft 46 has a first end portion revolvably connected to the stationary member 42, a second end portion securely connected to the holder member 47. The holder shaft 46 has a holder revolution axis 46a thereof, and is revolvable around the holder revolution axis 46a with respect to the stationary member 42 as seen by an arrow 46b in FIG. 6. The camera shaft 48 has a fixed end portion revolvably supported on the holder member 47 and a free end portion extending from the holder member 47. The camera shaft 48 has a camera revolution axis 48a thereof, and is revolvable around the camera revolution axis 48a with respect to the holder member 47 as seen by an arrow 48b in FIG. 6. In this embodiment, the camera revolution axis 48a of the camera shaft 48 is in perpendicular relationship with the holder revolution axis 46a of the holder shaft 46.

The holder member 47 is in the form of L-shape in cross-section and has a first plate portion 47a having a surface paralleled to that of the stationary member 42, and a second plate portion 47b integrally formed with the first plate portion 47a to have a surface to be perpendicular to that of the first plate portion 47a. The channel member 49 is securely mounted on the free end portion of the camera shaft 48 to retain the camera unit 43. The camera unit 43 is movable with respect to the stationary member 42 to a destined position and posture to be decided and controlled by a micro-computer unit which will become apparent as the description proceeds.

The surveillance camera apparatus 41 further comprises a micro-computer unit 52 for producing a position signal indicative of the destined position and posture, and a printed circuit board 51 for mounting the micro-computer unit 52. The printed circuit board 51 is shown as dismounted from the holder member 47 in FIG. 6 for the purpose of assisting in understanding, but the printed circuit board 51 is securely mounted on the holder member 47.

The micro-computer unit 52 is operative to take two different operation states consisting of a regular state to produce a regular state signal indicative of the regular state for every first predetermined time interval, and an irregular state not to produce the position signal. The micro-computer unit 52, for example, takes the irregular state when the micro-computer unit 52 is accidentally brought into a frozen state.

The surveillance camera apparatus 41 further comprises a resetting unit 53 for resetting the micro-computer unit 52 to the regular state from the irregular state, an I/O port 55 mounted on the printed circuit board 51 and adapted to transmit to the micro-computer unit 52 from an exterior controller 56 an operation command to have the micro-computer unit 52 operate to produce the position signal, a camera driving unit 57 for driving the camera unit 43 to revolve around the camera revolution axis 48a with respect to the holder member 47, and a holder driving unit 58 for driving the holder member 47 to revolve around the holder revolution axis 46a with respect to the stationary member 42. The resetting unit 53 is securely supported by the stationary member 42.

The camera driving unit 57 includes a camera electric motor 59 securely mounted on the holder member 47, a camera drive gear 60 driven by the camera electric motor 59, a camera driven gear 61 integrally coupled with the camera shaft 48 to be meshed with the camera drive gear 60 to be driven by the camera drive gear 60, and a camera encoder 62 for counting and encoding the revolution number of the camera electric motor 59. The camera drive gear 60 has a gear number smaller than that of the camera driven gear 61 to reduce the revolution of the camera shaft 48. It is preferable that the camera electric motor 59 and the camera encoder 62 are combined to be constituted by a step-motor.

The holder driving unit 58 includes a holder electric motor 63 securely mounted on the stationary member 42, a holder drive gear 64 driven by the holder electric motor 63, a holder driven gear 65 integrally coupled with the holder shaft 46 to be meshed with the holder drive gear 64 to be driven by the holder drive gear 64, and a holder encoder 66 for counting and encoding the revolution number of the holder electric motor 63. The holder drive gear 64 has a gear number smaller than that of the holder driven gear 65 to reduce the revolution of the holder shaft 46. It is preferable that the holder electric motor 63 and the holder encoder 66 are combined to be constituted by a step-motor.

The surveillance camera apparatus 41 further comprises a camera drive control unit 67 mounted on the printed circuit board 51 and adapted to control the camera driving unit 57 to have the camera driving unit 57 drive the camera unit 43 to revolve around the camera revolution axis 48a with respect to the holder member 47, and a holder drive control unit 68 mounted on the printed circuit board 51 and adapted to control the holder driving unit 58 to have the holder driving unit 58 drive the holder member 47 to revolve around the holder revolution axis 46a with respect to the stationary member 42 to the destined position and posture represented by the position signal produced by the micro-computer unit 52.

Each of the camera drive control unit 67 and holder drive control unit 68 is operative to take two different control states consisting of a first control state under which the camera unit 43 is driven to move to the destined position and posture represented by the position signal produced by the micro-computer unit 52, and a second control state under which the camera unit 43 is driven to move into engagement with the resetting unit 53 to have the micro-computer unit 52 to be reset. The camera unit 43 has a surveillance area where the camera unit 43 is driven by each of the camera driving unit 57 and holder driving unit 58 to move with respect to the stationary member 42 to taking an image of the specific object, and a non-surveillance area where the camera unit 43 is driven by the camera driving unit 57 and the holder driving unit 58 to move with respect to the stationary member 42 into engagement with the resetting unit 53 in the outside of the surveillance area. In this embodiment, the surveillance area is defined as a range in which the light axis 45a of the lens 45 of the camera unit 43 passes through a frame 45b, while the non-surveillance area is defined as outside of the surveillance area.

The surveillance camera apparatus 41 further comprises a control state setting unit 69 mounted on the printed circuit board 51. The control state setting unit 69 is operative to set each of the camera drive control unit 67 and holder drive control unit 68 to take the first control state when receiving the regular state signal from the micro-computer unit 52 within a second predetermined time interval longer than the first predetermined interval, while to set each of the camera drive control unit 67 and holder drive control unit 68 to take the second control state when not receiving the regular state signal from the micro-computer unit 52 within the second predetermined time interval.

The control state setting unit 69 includes signal receiving means for receiving the regular state signal produced by the micro-computer unit 52, interval measuring means for measuring a lap time interval starting from the time when the regular state signal is received by the signal receiving means, and time interval comparing means for comparing the lap time interval and the second predetermined time interval, and deciding whether or not the lap time interval exceeds the second predetermined time interval based on the compared lap time interval and second predetermined time interval.

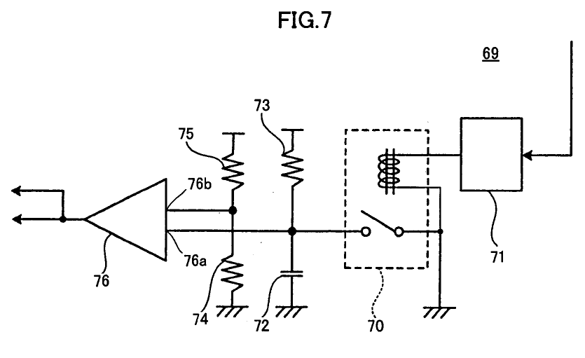

As best shown in FIG. 7, the interval measuring means includes a capacitor 72 for accumulating an electrical charge therein, the capacitor 72 having a first electrical potential associated with the lap time interval, and the capacitor 72 being designed to take two different states consisting of a first state to accumulate the electrical charge therein, and a second state to discharge the electrical charge, and a first resistor 73 for having the capacitor 72 accumulate the electrical charge.

The signal receiving means includes a relay-switch 70 for switching the state of capacitor 72 from the first state to the second state and vice versa, and a relay-switch driver 71 for driving the relay-switch 70 to have the relay-switch 70 switch the state of capacitor 72 from the first state to the second state and vice versa. The relay-switch driver 71 is operative to have the relay-switch 70 switch the state of the capacitor 72 to the first state from the second state when not receiving the regular state signal from the micro-computer unit 52, and to have the relay-switch 70 switch the state of the capacitor 72 to the second state from the first state when receiving the regular state signal from the micro-computer unit 52.

The time interval comparing means includes a voltage divider for producing a second electric potential associated with the second predetermined time interval. The voltage divider has a second resistor 74 electrically connected to the earth, and a third resistor 75 engaged. The time interval comparing means further includes a comparator 76 for comparing the first electric potential produced by the capacitor 72 to the second electric potential produced by the voltage divider. The comparator 76 is operative to judge whether or not the first electric potential produced by the capacitor 72 exceeds the second electric potential produced by the voltage divider based on the compared first and second electric potential.

The operation of the surveillance camera apparatus 41 will be described hereinafter with reference to in FIGS. 4 to 7.

Under the condition that the micro-computer unit 52 takes the regular state, the destined position and posture is firstly decided and controlled by the micro-computer unit 52. The position signal is then produced by the micro-computer unit 52, while the regular state signal is produced by the micro-computer unit 52 for every first predetermined time interval. In FIG. 4, the reference character “t1” represents the first predetermined time interval, and the reference characters “s1”, “s2”, “s3” and “s4” each represents the regular state signal produced by the micro-computer unit 52.

When the position signal produced by the micro-computer unit 52 is received by each of the camera drive control unit 67 and holder drive control unit 68, the camera driving unit 57 is controlled by the camera drive control unit 67 to drive the camera unit 43 to revolve around the camera revolution axis 48a with respect to the holder member 47 to the destined position and posture represented by the position signal, and the holder driving unit 58 is controlled by the holder drive control unit 68 to drive the holder member 47 revolve around the holder revolution axis 46a with respect to the stationary member 42 to the destined position and posture represented by the position signal.

When, on the other hand, the regular state signal produced by the micro-computer unit 52 is received by the signal receiving means of the control state setting unit 69, the lap time interval is started to be measured by the interval measuring means of the control state setting unit 69 in accordance with the first electric potential produced by the capacitor 72 of the interval measuring means. The first electric potential is represented by the reference character “d” in FIG. 4. The lap time interval measured by the interval measuring means is then compared by the time interval comparing means of the control state setting unit 69 to the second predetermined time interval. When the judgment is made by the time interval comparing means as the lap time interval exceeds the second predetermined time interval based on the compared lap time interval and second predetermined time interval, the first and second state are taken by each of the camera drive control unit 27 and holder drive control unit 68 based on results of the judgment by the time interval comparing means. In FIG. 4, the reference character “t2” represents the second predetermined time interval, and the reference character “Vt” represents the electric potential being in association with the second predetermined time interval.

When the micro-computer unit 52 is accidentally brought into the frozen state, the micro-computer unit 52 takes the irregular state under which the position signal and the regular state signal are not produced by the micro-computer unit 52. This leads to the fact that the lap time interval measured by the interval measuring means of the control state setting unit 69 exceeds the second predetermined time interval. Each of the camera drive control unit 67 and holder drive control unit 68 is then set by the control state setting unit 69 to take the second control state at the time, for example, represented by the reference character “T” in FIG. 4.

When each of the camera drive control unit 67 and holder drive control unit 68 is set by the control state setting unit 69 to take the second control state, the camera driving unit 57 is controlled by the camera drive control unit 67 to drive the camera unit 43 to revolve around the camera revolution axis 48a with respect to the holder member 47, and the holder driving unit 58 is controlled by the holder drive control unit 68 to drive the holder member 47 to revolve around the holder revolution axis 46a with respect to the stationary member 42. The camera unit 43 is then driven to move into engagement with the resetting unit 53 to have the resetting unit 53 reset the micro-computer unit 52 to take the regular state from the irregular state.

As will be understood from the foregoing description, the second preferred embodiment of the surveillance camera apparatus according to the present invention can be automatically reset without being operated by an operator when the micro-computer unit constituting part of the surveillance camera apparatus is brought into the frozen state, thereby the second preferred embodiment of the surveillance camera apparatus according to the present invention has an advantage over the prior art in reducing the operation time and lessening the laborious task for the operator to reset the micro-computer unit.

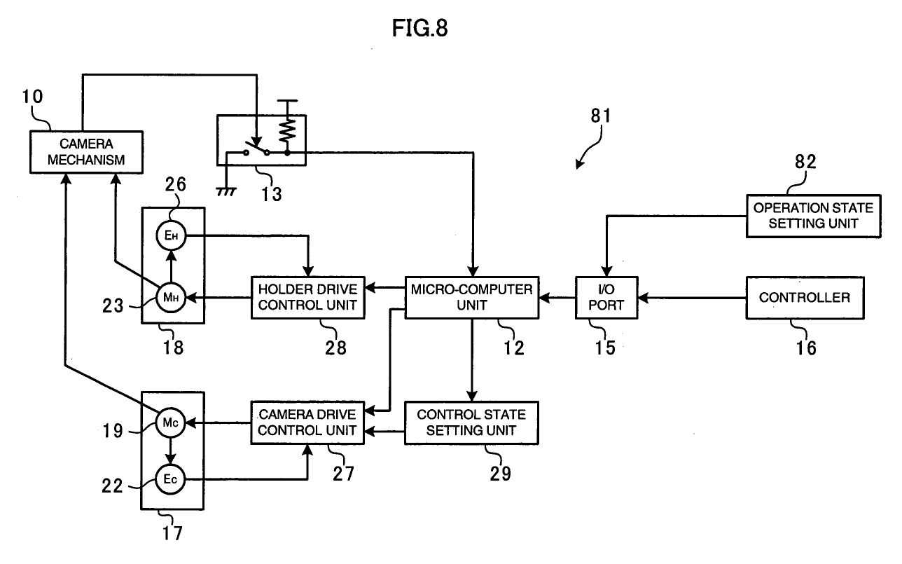

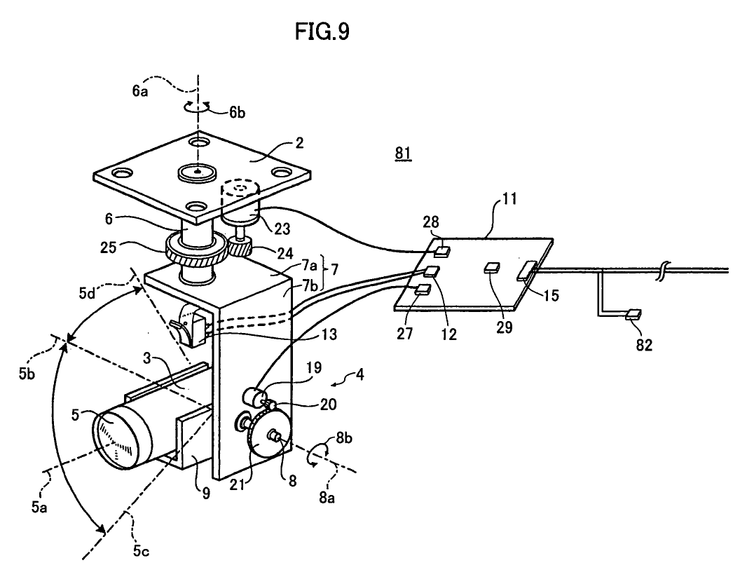

Referring then to FIGS. 8 and 9 of the drawings, there is shown the third preferred embodiment of the surveillance camera apparatus according to the present invention. The constitutional elements or parts of the third preferred embodiment of the surveillance camera apparatus according to the present invention as shown in FIGS. 8 and 9 are entirely the same as those of the first preferred embodiment of the surveillance camera apparatus according to the present invention as shown in FIGS. 1 and 2 except for the constitutional elements or parts appearing in the following description. Therefore, only the constitutional elements or parts of the third preferred embodiment of the surveillance camera apparatus different from those of the first preferred embodiment of the surveillance camera apparatus will be described in detail hereinafter. The constitutional elements or parts of the third preferred embodiment of the surveillance camera apparatus entirely the same as those of the first preferred embodiment of the surveillance camera apparatus will not be described but bear the same reference numerals and legends as those of the first preferred embodiment of the surveillance camera apparatus in FIGS. 1 and 2 to avoid tedious repetition.

The following description will be directed to the constitutional elements or parts of the third preferred embodiment of the surveillance camera apparatus different from those of the first preferred embodiment of the surveillance camera apparatus.

The third preferred embodiment of the surveillance camera apparatus is shown in FIGS. 8 and 9 as having a reference number 81, comprises the stationary member 2, the camera unit 3, the camera retaining assembly 4, the printed circuit board 11, the micro-computer unit 12, the resetting unit 13, the I/O port 15, the camera driving unit 17, the holder driving unit 18, the camera drive control unit 27, the holder drive control unit 28 and the control state setting unit 29, all of which are the same in construction as the first preferred embodiment of the surveillance camera apparatus 1 shown in FIGS. 1 and 2 and thus its construction will not be described hereinafter.

The surveillance camera apparatus 81 further comprises an operation state setting unit 82 for selectively setting the micro-computer unit 12 to take the regular and irregular states. It is preferable that the operation state setting unit 82 is constituted by part of the exterior controller 16. Further, it is preferable that the operation state setting unit 82 repeatedly sets the micro-computer unit 12 to take the regular and irregular states in predetermined time interval having two different time intervals consisting of a first time interval in which the micro-computer unit 12 is set to take the regular mode, and a second time interval in which the micro-computer unit 12 is set to take the irregular mode. In this case, the operation state setting unit 82 and the micro-computer unit 12 may be integrally formed with each other.

The operation of the surveillance camera apparatus 81 will be described hereinafter with reference to in FIG. 7 and 8. The following description will be directed to the constitutional operation of the third preferred embodiment of the surveillance camera apparatus different from those of the first preferred embodiment of the surveillance camera apparatus.

Under the conditions that the micro-computer unit 12 takes the regular state, when the micro-computer unit 12 is set by the operation state setting unit 82 to take the irregular state, the micro-computer unit 12 takes the irregular state under which the position signal and the regular state signal are not produced by the micro-computer unit 12. This leads to the fact that the lap time interval measuring by the interval measuring means of the control state setting unit 29 exceeds the second predetermined time interval The camera drive control unit 27 is then set by the control state setting unit 29 to take the second control state.

When the camera drive control unit 27 is set by the control state setting unit 29 to take the second control state, the camera driving unit 17 is controlled by the camera drive control unit 27 to drive the camera unit 3 to move into engagement with the resetting unit 13 to have the resetting unit 13 reset the micro-computer unit 12 to take the regular state from the irregular state.

As will be understood from the foregoing description, the third preferred embodiment of the surveillance camera apparatus according to the present invention has the same merits as the first preferred embodiment of the surveillance camera apparatus according to the present invention, and the third preferred embodiment of the surveillance camera apparatus according to the present invention can test for the function to be automatically reset without being operated by an operator when the micro-computer unit constituting part of the surveillance camera apparatus is brought into a frozen state.

While the present invention has thus been shown and described with reference to the specific embodiments, however, it should be noted that the invention is not limited to the details of the illustrated structures but changes and modifications may be made without departing from the scope of the appended claims.

What is claimed is:

1. A surveillance camera apparatus, comprising:
a camera unit for taking an image of a specific object;
a camera retaining assembly for retaining said camera unit, said camera unit being movable with respect to said camera retaining assembly to a destined position and posture;
a micro-computer unit for producing a position signal indicative of said destined position and posture, said micro-computer unit being operative to take two different operation states consisting of a regular state to produce a regular state signal indicative of said regular state for every first predetermined time interval, and an irregular state not to produce said position signal;
a resetting unit for resetting said micro-computer unit to take said regular state from said irregular state;
a camera driving unit for driving said camera unit to move with respect to said camera retaining assembly;
a camera drive control unit for controlling said camera driving unit to have said camera driving unit drive said camera unit to move with respect to said camera retaining assembly, said camera drive control unit being operative to take two different control states consisting of a first control state under which said camera unit is driven to move to said destined position and posture represented by said position signal produced by said micro-computer unit, and a second control state under which said camera unit is driven to move into engagement with said resetting unit to have said micro-computer unit to be reset; and
a control state setting unit for setting said camera drive control unit to take said first control state when receiving said regular state signal from said micro-computer unit within a second predetermined time interval longer than said first predetermined interval, while setting said camera drive control unit to take said second control state when not receiving said regular state signal from said micro-computer unit within said second predetermined time interval.

2. A surveillance camera apparatus as set forth in claim 1, in which said camera unit has a surveillance area where said camera unit is driven by said camera driving unit to move with respect to said camera retaining assembly to taking an image of said specific object, and a non-surveillance area where said camera unit is driven by said camera driving unit to move with respect to said camera retaining assembly into engagement with said resetting unit in the outside of said surveillance area.

3. A surveillance camera apparatus as set forth in claim 1, in which said control state setting unit includes:
signal receiving means for receiving said regular state signal produced by said micro-computer unit;
interval measuring means for measuring a lap time interval starting from the time when said regular state signal is received by said signal receiving means; and
time interval comparing means for comparing said lap time interval and said second predetermined time interval, and deciding whether or not said lap time interval exceeds said second predetermined time interval based on said compared lap time interval and second predetermined time interval.

4. A surveillance camera apparatus as set forth in claim 1, which further comprises:
an operation state setting unit for selectively setting said micro-computer unit to take said regular and irregular states.

5. A surveillance camera apparatus as set forth in claim 1, which further comprises:
an operation state setting unit for repeatedly setting said micro-computer unit to take said regular and irregular states in predetermined time interval having two different time intervals consisting of a first time interval in which said micro-computer unit is set to take said regular mode, and a second time interval in which said micro-computer unit is set to take said irregular mode.

6. A surveillance camera apparatus as set forth in claim 1, in which said camera retaining assembly includes a camera shaft having a camera revolution axis thereof, and a holder member for revolvably supporting said camera shaft; and
said camera shaft is driven in unison with said camera by said camera driving unit to revolve around said camera revolution axis with respect to said camera retaining assembly.

7. A surveillance camera apparatus as set forth in claim 6, in which said camera retaining assembly includes a holder shaft securely mounted on said holder member and having a holder revolution axis thereof, and which further comprises:
a stationary member;
a holder driving unit for driving said holder member of said camera retaining assembly to revolve around said holder revolution axis with respect to said stationary member; and
a holder drive control unit for controlling said holder driving unit to have said holder driving unit drive said holder member to revolve around said holder revolution axis with respect to said stationary member to said destined position and posture represented by said position signal produced by said micro-computer unit;

8. A surveillance camera apparatus, comprising:
a stationary member;
a camera unit for taking an image of a specific object;
a camera retaining assembly for retaining said camera unit, said camera retaining assembly including a camera shaft having a camera revolution axis thereof, a holder member for revolvably supporting said camera shaft to revolve around said camera revolution axis with respect to said holder member, and a holder shaft having a holder revolution axis thereof, said holder shaft securely mounted on said holder member and being supported by said stationary member to revolve around said holder revolution axis with respect to said stationary member, and said camera unit being revolvable with respect to said stationary member and said holder member to a destined position and posture;
a micro-computer unit for producing a position signal indicative of said destined position and posture, said micro-computer unit being operative to take two different operation states consisting of a regular state to produce a regular state signal indicative of said regular state for every first predetermined time interval, and an irregular state not to produce said position signal;
a resetting unit for resetting said micro-computer unit to take said regular state from said irregular state;
a camera driving unit for driving said camera unit to revolve around said camera revolution axis with respect to said holder member;
a holder driving unit for driving said holder member of said camera retaining assembly to revolve around said holder revolution axis with respect to said stationary member;
a camera drive control unit for controlling said camera driving unit to have said camera driving unit drive said camera unit to revolve around said camera revolution axis with respect to said holder member;
a holder drive control unit for controlling said holder driving unit to have said holder driving unit drive said holder member to revolve around said holder revolution axis with respect to said stationary member, said camera drive control unit and said holder drive control unit being respectively operative to take two different control states consisting of a first control state under which said camera unit is driven to move to said position and posture represented by said position signal produced by said micro-computer unit, and a second control state under which said camera unit is driven to move into engagement with said resetting unit to have said micro-computer unit to be reset; and
a control state setting unit for setting each of said camera drive control unit and holder drive control unit to take said first control state when receiving said regular state signal from said micro-computer unit within a second predetermined time longer than said first predetermined interval, while setting each of said camera drive control unit and holder drive control unit to take said second control state when not receiving said regular state signal from said micro-computer unit within said second predetermined time.
